(19) United States
(12) Patent Application Publication
(10) Pub. No.: US 2026/0077859 A1
(43) Pub. Date: Mar. 19, 2026

(54) CEILING PANEL HAVING A LIGHT MODULE FOR AN AIRCRAFT AND AIRCRAFT EQUIPPED WITH A CEILING PANEL

(71) Applicants: Airbus Operations GmbH, HAMBURG (DE); Airbus Americas, Inc., MOBILE, AL (US)

(72) Inventors: Kim Michael Franz, HAMBURG (DE); Albert Schönwald, HAMBURG (DE); Aaron Mallette, MOBILE, AL (US)

(21) Appl. No.: 19/317,543

(22) Filed: Sep. 3, 2025

Related U.S. Application Data
(60) Provisional application No. 63/694,364, filed on Sep. 13, 2024.

(51) Int. Cl. B64D 11/00; F21V 3/04; F21V 23/00; F21W 106/00; F21W 107/30

(52) U.S. Cl. CPC B64D 11/00; F21V 3/049; F21V 23/001; B64D 2011/0038; B64D 2221/00; F21W 2106/00; F21W 2107/30

(57) ABSTRACT

A ceiling panel for an aircraft with a base panel and a light module. The base panel has a base plate and two side plates extending from a bottom surface of the base plate. The two side plates form a personal service channel on a respective interior side, the personal service channel configured to support at least one personal service unit. The light module is connected to the base plate on an exterior side of one of the two side plates.

### RELATED APPLICATIONS

This application claims priority to United States Provisional Ser. No. 63/694,364 filed on Sep. 13, 2024, the entire disclosure of which is incorporated by reference.

### FIELD OF THE INVENTION

The present disclosure generally relates to a ceiling panel for an aircraft. Particularly, the present disclosure relates to a ceiling panel including a light module that can be installed in an aircraft, such as in a welcome area close to a door of the aircraft as well as in a high ceiling region.

### BACKGROUND OF THE INVENTION

A conventional ceiling in a welcome area close to a door of the aircraft includes ceiling panels and some light emitting elements that are hidden to provide indirect lighting to the welcome area. As a mere example, a light-emitting element may be arranged on an upper side of a light panel, while another ceiling panel is arranged thereabove, to reflect the light emitted by the light emitting element.

### SUMMARY OF THE INVENTION

It is an object of the present disclosure to provide an improved ceiling panel having a light emitting element.

This object may be solved by the present invention as defined in the various embodiments described herein.

According to a first aspect to better understand the present disclosure, a ceiling panel for an aircraft comprises a base panel, and a light module. The base panel comprises a base plate and two side plates extending from a bottom surface of the base plate. The two side plates form a personal service channel on a respective interior side, and the light module is connected to the base plate on an exterior side of one of the two side plates. In other words, the base plate has a Pi-shape (π-shape), and the personal service channel is arranged in the interior space of the Pi, while the light module is arranged on an outer side. The personal service channel (PSC) is configured to support at least one personal service unit (PSU). For instance, the PSU can be received in the PSC and mounted therein. A PSU usually comprises personal passenger equipment, such as oxygen mask, loudspeaker, reading light, indicating lights or images, et cetera.

Thus, decoupling of functional components of the ceiling panel, particularly providing the base panel separate from the light module, allows providing an individual PSC in the aircraft. Thus, the light module(s) may be removed (e.g., for maintenance, exchange and/or replacement) without affecting the personal service units in the PSC. This relieves from the burden of testing the PSUs after a removal and/or installation of an illuminated ceiling panel with integrated PSC and PSUs. For instance, if a conventional ceiling panel including a PSC is detached from the aircraft structure, the PSUs have to be tested after re-installation of the ceiling panel.

The disclosed ceiling panel can be employed in an area of the aircraft, where regularly a plurality of PSUs is installed. In addition to the PSUs, a light module can be provided. This allows installing the disclosed ceiling panel not only in a welcome area of the aircraft (e.g., in the center of the aircraft close to a door), but also in an area referred to as a high ceiling area. Such high ceiling area can be provided in a higher-class passenger cabin, such as business class or first class. In the center of the aircraft there are passenger seats installed, but due to the reduced number of passengers in the entire area, the overall number of overhead stowage compartments is reduced, and the center overhead stowage compartments are omitted. This provides for a more open space cabin. Thus, the disclosed high ceiling panel will be arranged above passenger seats, such as in the transverse center of the aircraft, and the required personal service channel is enhanced by the light module arranged next to the PSC.

Moreover, due to the modularity of the ceiling panel, ergonomic rules applicable during installation (final assembly line—FAL) can be fulfilled. Likewise, maintenance and/or replacement of the light module can be performed in an easy and fast manner still under ergonomic rules.

In a variant, the ceiling panel can further comprise a further light module connected to the base plate on an exterior side of the other one of the two side plates. In other words, the ceiling panel can have a symmetric cross-section with the PSC in the center and two oppositely arranged light modules.

In a variant, the ceiling panel can further comprise another light module configured to fit into the personal service channel and to be mounted to the base plate in the personal service channel. Thus, the ceiling panel can be provided with one to three light modules in any desired manner. This renders the disclosed ceiling panel a flexible interior component of the aircraft providing light that can be employed in a plurality of locations inside of the passenger cabin.

As a mere example, in a welcome area (the center ceiling area visible when entering the aircraft through an aircraft door) may be provided with a ceiling panel having a plurality of light modules, including a center light module mounted in the PSC. An adjacent ceiling panel in the longitudinal direction of the aircraft, i.e., a ceiling panel towards the passenger cabin but before a seating area, may then be provided with two or three light modules. Even further into the passenger cabin, particularly where the seating area begins, ceiling panel can be provided with personal service units in the PSC and one or two light modules adjacent thereto.

In a variant, the base plate can comprise a tongue configured to hold a portion of the light module, and a snap-and-click device configured to receive a latch of the light module. The tongue allows to hang the light module to the base plate in a more or less loose manner, while the snap-and-click device then fixedly mounts the light module to the base plate. For instance, the tongue may extend in a direction along which the latch of the light module is inserted into the snap-and-click device. This allows mounting the light module without specific fasteners, and the light module is hold by the snap-and-click device in at least one direction and is hold by the tongue in at least another direction. As mere examples, the tongue and latch may extend in the transverse direction of the aircraft, so that the light module is held in the longitudinal direction of the aircraft and a vertical direction by the tongue and is further held in the transverse direction (and optionally in the longitudinal direction and vertical direction) by the snap-and-click device.

In a variant, the base plate can comprise a Bowden cable configured to bring the snap-and-click device into an open position releasing the latch. Thus, the snap-and-click device can be opened to release the latch from a position spaced apart from the snap-and-click device. This facilitates installation and deinstallation of the light module, without the necessity of fasteners and specific tools.

In a variant, the base plate can further comprise an activation mechanism coupled to the Bowden cable and arranged at a lateral side of the base plate. Since the lateral side of the base plate is further away from a center of the ceiling panel, the activation mechanism can be easier reached, even if it is arranged above the light module. As a mere example, the activation mechanism may include a loop, hook or recess, into which a hooked tool can be inserted to pull the Bowden cable. Thus, deinstallation of the light module can be performed fast and in an easy manner, while the activation mechanism can be hidden (is not visible for passengers).

In a variant, the base plate can further comprise an activation mechanism coupled to the Bowden cable and arranged at an upper surface of the base plate, opposite to the bottom surface where the light module is arranged. If this upper surface can be reached with a corresponding tool, the activation mechanism can be easily activated, in order to pull the Bowden cable and open the snap-and-click device.

It is to be understood that in any of the variants, the activation mechanism may include a motorized actuator (an electric motor, hydraulic or pneumatic actuator, or the like) that may allow pulling the Bowden cable and opening the snap-and-click device. Alternatively, the activation mechanism, particularly the motorized actuator can be arranged at or integrated into the snap-and-click device, i.e., omitting the Bowden cable. The activation mechanism may be triggered electrically, hydraulically or pneumatically from a remote trigger mechanism.

In a variant, the light module can comprise a receptacle configured to receive the tongue. The receptacle can be a recess or opening in the light module or a component thereof. Alternatively or additionally, a receptacle may be mounted to a component of the light module providing an opening and interior space configured to receive the tongue, such as a bracket or the like. As a mere example, the receptacle can be a hook or a tubular component having an opening and an interior space of dimensions slightly larger than the dimensions of the tongue.

In a variant, the light module can comprise a main plate, wherein a plurality of light emitting elements is provided on a bottom surface of the main plate. Thus, the light module can be easily manufactured by placing the light emitting elements onto the main plate and then install the main plate into the light module, such as into a housing of the light module. It is to be understood that the light-emitting elements may also be mounted onto the main plate after the main plate is installed in the light module.

In a variant, the light module can comprise a diffusion and/or patterned plate, wherein the light emitting elements emit light towards the diffusion and/or patterned plate. Thus, a direct lighting can be provided in the aircraft, which provides an improved light appearance and better homogeneity. In addition, a uniform light distribution can be achieved and/or visual effects on the ceiling of the aircraft (the passenger cabin) can be achieved.

In a variant, the ceiling panel can further comprise a first electric cable with an interface provided at the base plate, and a second electric cable with an interface provided at the light module. The interface of the first electric cable and the interface of the second electric cable are configured to be coupled to one another and to achieve an electric connection of the first and second electric cables. This facilitates installation, replacement and deinstallation of the light module, without affecting the base plate and, particularly, without affecting the personal service channel and personal service units.

In a variant, the interfaces at the base plate and the light module can be configured and arranged to be coupled with one another, when the light module is attached to the snap-and-click device. For instance, a plug-in direction of the interfaces can correspond to the direction of the latch moving into the snap-and-click device. As a mere example, the interfaces of the base plate and the light module can be integrated into the latch of the light module and the snap-and-click device at the base plate, so that an electric connection can be achieved simultaneously with the mounting of the light module to the base plate.

In a variant, the ceiling panel can further comprise a personal service mounting bar provided at each of the two side plates. The personal service mounting bar is configured to hold at least one personal service unit and/or at least one cover. The personal service mounting bar can be a standardized mounting bar, to which personal service units and covers can be installed. A cover is configured to cover/close the bottom side of the PSC and can be provided particularly in an area of the PSC, where no PSU or other component is to be installed.

In a variant, the ceiling panel can further comprise a blind element configured to be connected to the base plate instead of a light module. The blind element can be mounted to the base plate in the same manner as a light module, for example, via the tongue and/or snap-and-click device. The blind element may have a similar or the same cross-sectional shape as a light module. However, the blind element is not equipped with any light emitting device, so that it simply covers the base plate at the exterior side of the PSC, for example, where no light module is to be installed.

According to a second aspect to better understand the present disclosure, an aircraft comprises at least one ceiling panel of the first aspect or one or more of its variants.

The present disclosure is not restricted to the aspects and variants in the described form and order. Specifically, the description of aspects and variants is not to be understood as a specific limiting grouping of features. It is to be understood that the present disclosure also covers combinations of the aspects and variants. Thus, each variant or optional feature can be combined with any other aspect, variant, optional feature or even combinations thereof.

### BRIEF DESCRIPTION OF THE DRAWINGS

In the following, the present disclosure will further be described with reference to exemplary implementations illustrated in the figures, in which:

FIG. 1 schematically illustrates a cross-section of a ceiling panel;

FIG. 2 schematically illustrates a perspective view of a base plate of a ceiling panel;

FIG. 3 schematically illustrates a bottom view of a base plate;

FIG. 4 schematically illustrates a perspective view of a partially open light module;

FIG. 5 schematically illustrates a cross-section of a light module;

FIG. 6 schematically illustrates a perspective view of a light module;

FIG. 7 schematically illustrates a side view of a portion of a light module;

FIG. 8 schematically illustrates a top view of the portion of the light module of FIG. 7; and

FIG. 9 schematically illustrates an aircraft comprising a plurality of ceiling panels.

### DETAILED DESCRIPTION OF THE PREFERRED EMBODIMENTS

In the following description, for purposes of explanation and not limitation, specific details are set forth in order to provide a thorough understanding of the present disclosure. It will be apparent to one skilled in the art that the present disclosure may be practiced in other implementations that depart from these specific details.

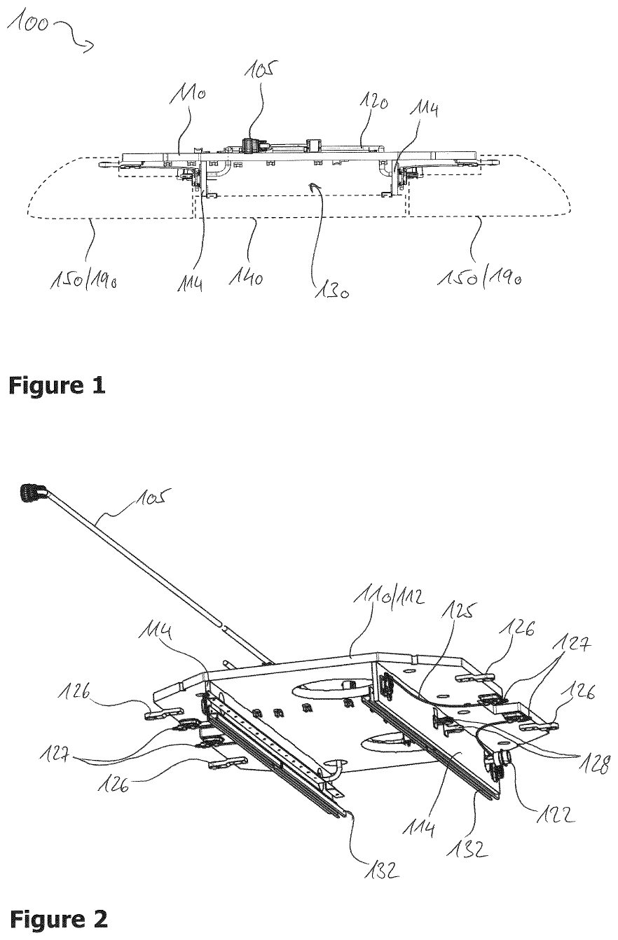

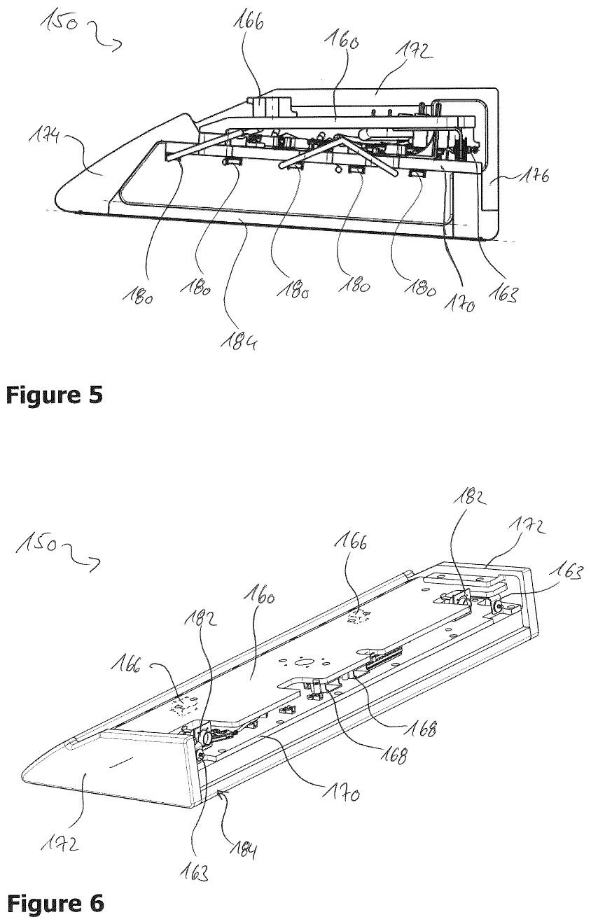

FIG. 1 schematically illustrates a cross-section of a ceiling panel 100. The ceiling panel comprises a base panel 110 and at least one light module 150. FIG. 1 illustrates two light modules 150 on each side of the ceiling panel 100. Instead of a light module 150, a blind element 190 can likewise be provided as will be explained with respect to FIGS. 5 and 6. Therefore, the light modules 150 and/or blind elements 190 are illustrated in dashed lines.

In the following reference may be made to a light module 150. It is to be understood that the same disclosure also applies to a blind element 190, since it is a very similar module as a light module 150, but without light emitting elements.

With additional reference to FIG. 2, the base panel 110 comprises a base plate 112 and two side plates 114 extending from a bottom surface of the base plate 112. The base plate and the two side plates have a substantially Pi-shape (π-shape). Between the two side plates 114, a personal service channel 130 is formed. Particularly, the personal service channel 130 (PSC) is formed on a respective interior side of the two side plates 114. The PSC 130 is configured to support at least one personal service unit 140 (PSU). Although FIG. 1 illustrates PSU 140 as being arranged below the side plates 114, it is to be understood that the present disclosure is not limited to this location of the PSU 140, but that the PSU 140 can likewise be provided closer to the base plate 112, i.e., between the two side plates 114.

The PSC 130 and PSU 140 are standardized and conventional items. In the present disclosure, however, the PSC 130 is provided and formed by the side plates 114 and a portion of the base plate 112, so that the PSC 130 is integrated into the ceiling panel 100, instead of being a separate component as in conventional installations. Thus, the description of details of the PSC 130 and PSU 140 is omitted for sake of brevity.

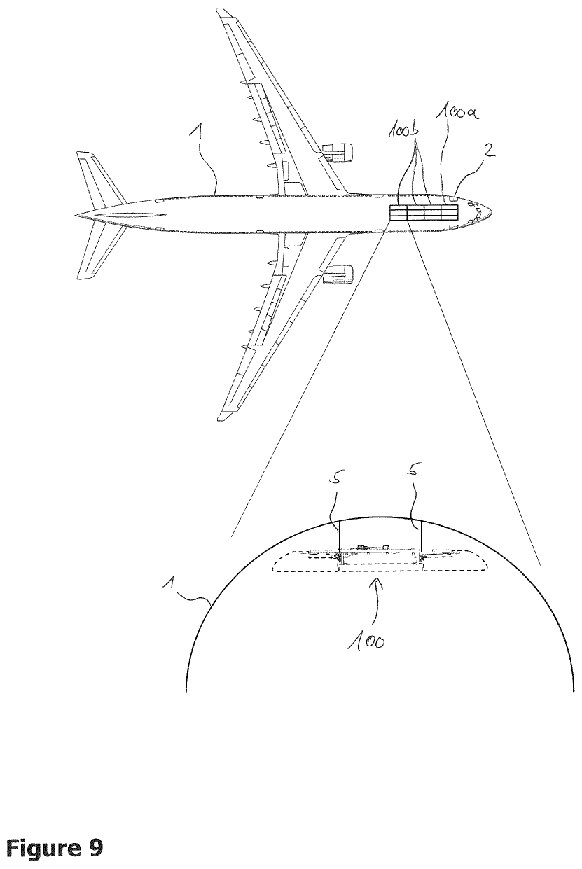

The base plate 112 can be mounted on its upper side (top side in FIG. 1) to a structure 5 of an aircraft 1 (see FIG. 9). Such structure 5 of the aircraft 1 can be the same as conventionally used to mount a ceiling lining, a PSU and/or an overhead stowage compartments. As a mere example, brackets mounted to a frame and/or stringer of the aircraft or an installation rail 5 can be provided in the aircraft 1, to which the base plate 112 can be mounted.

The ceiling panel 100 comprises a supply line 105, such as one or more of an electric cable, data cable, oxygen tube or hose and the like that provides an electric current, a data signal and/or oxygen to the ceiling panel 100. The supply line 105 can be provided for the light module 150 as well as for the PSC 130 and PSUs 140. The supply line 105 may be arranged on a top side/surface of the base plate 112.

The ceiling panel 100 can further comprise a first electric cable 120 with an interface 122. Such first electric cable 120 may be electrically connected to the supply line 105. The first electric cable 120 and interface 122 are configured to be connected to a light module 150, in order to supply electric energy to the light module 150. In addition, an interface 122 and a corresponding first electric cable 120 may be provided in plurality with respect to each side plate 114. This allows electrically connecting a light module 150 on each side of the ceiling panel 100.

The first electric cable 120 may run through an opening in the base plate 112, so that it can be connected on a top side/surface of the base plate 112 to the supply line 105. The interface 122 may be provided on an exterior side of the corresponding side plate 114. Thus, an opening in the side plate 114 may be provided for the cable to run through or for the interface to be arranged in the opening.

In order to connect the light module 150 (or the blind 190) to the base plate 112, mounting components are provided at the base plate 112, so that the light module 150 or the blind 190 can be connected to the base plate 112 on an exterior side of one of the two side plates 114.

For instance, the base plate 112 can comprise a tongue 126 configured to hold a portion of the light module 150. Such tongue 126 can be arranged at a lateral side/end/edge of the base plate 112, and may extend over the lateral side or edge of the base plate 112.

Alternatively or additionally, a tongue 128 can be provided at one of the side plates 114 extending therefrom in a direction substantially perpendicular to the side plate 114. The tongue 128 can also be provided at a bottom surface of the base plate 112, similar to tongue 126 but closer to the side plate 114.

The ceiling panel 100, particularly the base panel 110, can further comprise a snap-and-click device 123 configured to receive a latch 163 (FIG. 6) of the light module 150. Optionally, the base panel 110 can comprise a Bowden cable 125 configured to bring the snap-and-click device 123 into an open position releasing the latch 163. This may be achieved by an activation mechanism 127 coupled to the Bowden cable 125 at an opposite end of the Bowden cable 125 than the snap-and-click device 123. As a mere example, the activation mechanism 127 may be arranged at a lateral side of the base plate 112.

All of the described components of the base plate 112 may be provided in plurality, and in a symmetric manner, in order to provide the same functionality on each side of the base plate 112, i.e., on the exterior side of each of the side plates 114.

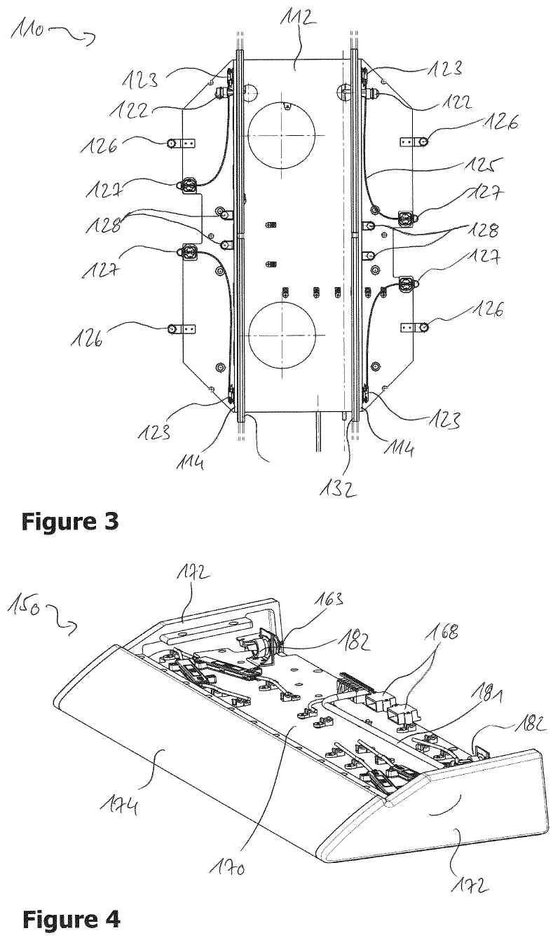

FIG. 3 schematically illustrates a bottom view of the base panel 110, where exemplary locations of the tongues 126, 128, the Bowden cables 125, the activation mechanisms 127 and the interfaces 122 are illustrated.

With reference to FIGS. 1 to 3, the ceiling panel 100 may further comprise a personal service mounting bar 132 provided at each of the two side plates 114. This bar 132 can be configured to hold at least one personal service unit 140 and/or at least one cover (not illustrated). Such mounting bar 132 may be a conventional and/or standardized mounting bar 132, so that any available PSU 140 can be installed. The cover may be a simple plate that closes a portion of the PSC 130, for example, where no PSU 140 or other component is installed in the PSC 130.

Turning to FIGS. 4 and 5 schematically illustrating a perspective view of a partially open light module 150 and a cross-section of the light module 150, respectively, the light module 150 comprises a main plate 170 arranged in a vertical middle or center of the light module 150. A plurality of light emitting elements 180 can be provided on a bottom surface of the main plate 170, so that the light emitting elements 180 emit light downwards, i.e., away from the main plate 170.

The light module 150 can further comprise a diffusion and/or patterned plate 184. Thus, the light emitted by the light emitting elements 180 is directed towards the diffusion and/or patterned plate 184. The diffusion plate achieves a homogeneous light distribution, while the direct light emission allows a bright illuminance of the passenger cabin. In addition, if the plate 184 includes a pattern, the passenger cabin can be provided with a specific visual effect. As a mere example, circles and/or stars may be used to form the pattern, which achieves a visual effect similar to a sky.

On the top side or surface of the main plate 170, the light module 150 comprises at least one receptacle 168 configured to receive a tongue 128. Thus, the light module 150 can be moved from an outer side of the ceiling panel 100 towards the corresponding side plate 114 until the receptacle 168 receives the tongue 128. In this moment, the light module 150 hangs on the tongue and facilitates further installation of the light module 150.

Likewise, with respect to FIGS. 5 to 8, a top plate 160 of the light module 150 may be arranged above and substantially parallel to the main plate 170. On the top surface of the top plate 160, there may be one or more further receptacles 166 configured to receive a tongue 126. The functionality of the receptacles 166 is the same as that of the receptacles 168, and facilitate installation of the light module 150.

In addition to the receptacles 166, 168 and tongues 126, 128, the light module 150 may comprise a latch 163. The latch 163 is provided at a position corresponding to the snap-and-click device 123 of the base panel 110, so that the snap-and-click device 123 can receive an associated latch 163, for example, when the tongues 126, 128 are received in the associated receptacles 166, 168. Thus, the light module 150 may simply be pushed towards the associated side plate 114, until the latch 163 (or latches 163) is caught and fixedly held by the snap-and-click device 123.

As can be derived from FIGS. 3 and 5, in order to deinstall a light module 150, a staff member may use a tool (e.g., including a hook or the like) to reach the activation mechanism 127 which is arranged (above and) at a side edge of the top plate 160, e.g., at a position corresponding to receptacle 166 in FIG. 5. This position can be easily reached by the tool, and the staff member can simply pull the activation mechanism and, hence, the Bowden cable 125 to bring the snap-and-click device 123 into the open position, where it releases the latch 163. Then, the light module 150 can simply be pulled away from the base plate 112, i.e., off the tongues 126, 128.

Furthermore, the ceiling panel 100 further comprises a second electric cable 181 with an interface 182 provided at the light module 150. FIG. 4 exemplarily illustrates the second electric cable 181 and associated interface 182 as being arranged on top of the main plate 170. This allows provision of an electric distribution on the main plate 170, in order to supply electric power to all light sources 180 provided on the bottom surface of the main plate 170.

The interface 122 of the first cable 120 can be coupled with the interface 182 of the second electric cable 181 at the light module 150, in order to achieve an electric connection between the first and second electric cables 120, 181. Thus, each light module 150 can easily be electrically connected to the power supply 105.

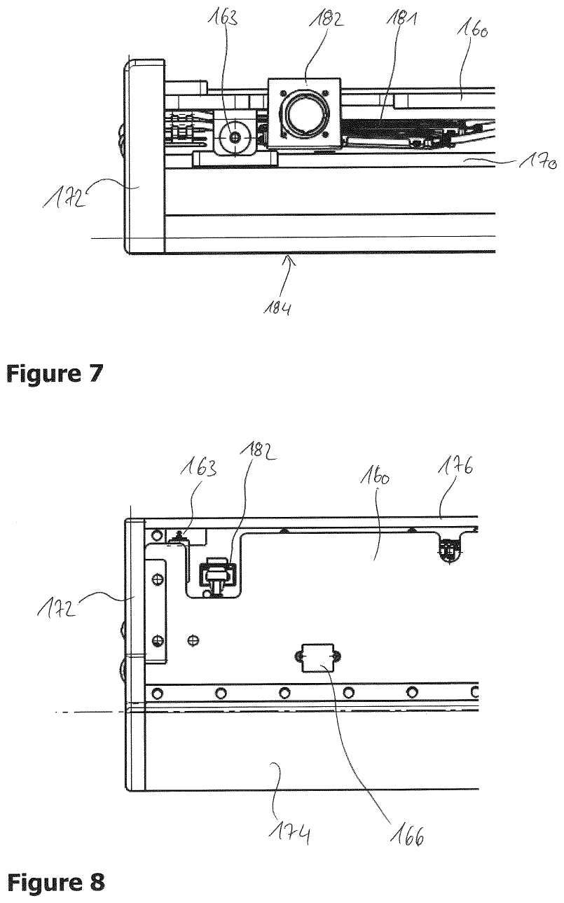

As a mere example, and with reference to FIGS. 3 and 7, the interfaces 122, 182 can be magnetic interfaces, that include corresponding magnets (not illustrated). Such magnets may couple the interfaces 122, 182 when brought close to one another, such as during pushing the light module 150 towards the side plate 114. Due to the receptacles 166, 168 as well as the latch 163 and the corresponding features of the base panel 110 (i.e., tongues 126, 128, and snap-and-click device 123) the light module 150 is already in a position close to matching positions of the interfaces 122, 182. Thus, the magnets may then achieve a simple connection of the interfaces 122, 182 and proper electric connection of the first and second cables 120, 181. In this connection of the electric cables 120, 181 can simply be performed by pulling the light module 150 away from the base panel 110.

With reference to FIGS. 4 to 6, the light module 150 is illustrated as having a housing consisting of two side plates 172, a front plate 174 and a back plate 176 (which is optional, as it requires several openings and recesses for the connection to the base panel 110). In other words, the light module 150 is housed in a box-like manner, with the diffusion and/or patterned plate 184 at the bottom and the top plate 172 at the top.

If a ceiling panel 100 does not require a light module 150, a blind element 190 may be provided that is configured to be connected to the base panel 110 and is shaped similar to the light module 150. For instance, the plates 172, 174, 176 may be employed to form a blind element 190. At the bottom, the same diffusion and/or patterned plate 184 may be provided, or a simple bottom plate (not explicitly illustrated) of the same style as the side plates 172 may be installed. In any case, the main plate 170 of a module 150 can be omitted, as no light emitting elements 150 are required.

Thus, only the top plate 160 having the receptacles 166 may be provided. In this case, since the main plate 170 is not present, the receptacles 168 can be mounted to the bottom surface of the top plate 160 which may be derived from the illustration of FIG. 6, where the receptacles 168 are shown quite close to the bottom surface of the top plate 160. Thus, with the receptacles 166, 168 and the latches 163, the blind element 190 can be mounted and dismounted to/from the base panel 110 in the same manner as the light module 150.

FIG. 9 schematically illustrates an aircraft 1 comprising a plurality of ceiling panels 100. Each of the ceiling panels 100 can have features of the ceiling panels 100 illustrated and described with respect to one of FIGS. 1 to 8.

The ceiling panel 100a may be arranged in a welcome area, i.e., close to an aircraft door 2, while further ceiling panels 100b are arranged adjacent thereto along the longitudinal direction of the aircraft 1 and towards the passenger cabin.

FIG. 9 additionally illustrates a partial cross-section of the aircraft 1 to explain an exemplary mounting of a ceiling panel 100 to an installation rail 5. As can be derived from the illustration, the base plate 112 can be mounted to an installation rail 5, which can be a regular installation component that is conventionally used in an aircraft 1.

It is to be understood that the scale of the ceiling panel 100 relative to the aircraft 1 may not correspond to an actual ceiling panel 100 and aircraft 1. Rather, the ceiling panel 100 is illustrated in an enlarged manner, in order to still identify elements thereof.

In this disclosure, terms such as “bottom”, “lower”, “top”, “upper” and the like were used. Such terms are to be understood to indicate a direction or side of component when the ceiling panel 100 is installed in an aircraft 1

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

It is believed that the advantages of the technique presented herein will be fully understood from the foregoing description, and it will be apparent that various changes may be made in the form, constructions and arrangement of the exemplary aspects thereof without departing from the scope of the disclosure or without sacrificing all of its advantageous effects. Because the technique presented herein can be varied in many ways, it will be recognized that the disclosure should be limited only by the scope of the claims that follow. Claimed is:

1. A ceiling panel for an aircraft, comprising:
a base panel; and
a light module,
wherein the base panel comprises a base plate and two side plates extending from a bottom surface of the base plate,
wherein the two side plates form a personal service channel on a respective interior side, the personal service channel configured to support at least one personal service unit, and
wherein the light module is connected to the base plate on an exterior side of one of the two side plates.

2. The ceiling panel of claim 1, wherein the base plate comprises a tongue configured to hold a portion of the light module, and a snap-and-click device configured to receive a latch of the light module.

3. The ceiling panel of claim 2, wherein the base plate comprises a Bowden cable configured to bring the snap-and-click device into an open position releasing the latch.

4. The ceiling panel of claim 3, wherein the base plate further comprises an activation mechanism coupled to the Bowden cable and arranged at a lateral side of the base plate.

5. The ceiling panel of claim 2, wherein the light module comprises a receptacle configured to receive the tongue.

6. The ceiling panel of claim 1, wherein the light module comprises a main plate, and
wherein a plurality of light emitting elements is provided on a bottom surface of the main plate.

7. The ceiling panel of claim 6, wherein the light module comprises a diffusion plate, or a patterned plate, or both, and
wherein the light emitting elements emit light towards the diffusion plate, or the patterned plate, or both.

8. The ceiling panel of claim 1, further comprising:
a first electric cable with an interface provided at the base plate; and
a second electric cable with an interface provided at the light module,
wherein the interface of the first electric cable and the interface of the second electric cable are configured to be coupled to one another and to achieve an electric connection of the first and second electric cables.

9. The ceiling panel of claim 1, further comprising:
a personal service mounting bar provided at each of the two side plates, the personal service mounting bar being configured to hold at least one personal service unit, or at least one cover, or both.

10. The ceiling panel of claim 1, further comprising:
a blind element configured to be connected to the base plate instead of a light module.

11. An aircraft comprising:
at least one ceiling panel of claim 1.
